(19) United States
(12) Patent Application Publication
(10) Pub. No.: US 2026/0251239 A1
(43) Pub. Date: Aug. 27, 2026

(54) AIR-CONDITIONER DECORATION TUBE

(71) Applicant: Tinggui WANG, Zhongshan (CN)

(72) Inventor: Tinggui WANG, Zhongshan (CN)

(21) Appl. No.: 19/302,122

(22) Filed: Aug. 18, 2025

(30) Foreign Application Priority Data
Feb. 26, 2025 (CN) 202520322187.0

(51) Int. Cl. F16L 7/00; F16L 57/06; F16L 3/10; F16L 11/11; F16L 21/06; F16L 43/00

(52) U.S. Cl. CPC F16L 7/00; F16L 57/06; F16L 3/10; F16L 11/11; F16L 21/06; F16L 43/008

(57) ABSTRACT

The present disclosure discloses an air-conditioner decoration tube. The air-conditioner decoration tube includes a straight tube. The straight tube includes a first tube housing and a second tube housing, and has a first state and a second state. In the first state, the first tube housing is embedded in the second tube housing, and an outer surface of the first tube housing is covered by the second tube housing. In the second state, the first tube housing is connected to the second tube housing in such a manner that a tube cavity is enclosed by the first tube housing and the second tube housing.

### CROSS-REFERENCE TO RELATED APPLICATION

This application claims priority to Chinese Patent Application No. 202520322187.0, filed on February 26, 2025, which is hereby incorporated by reference in its entirety.

### FIELD

The present disclosure relates to the technical field of air-conditioners, and in particular, to an air-conditioner decoration tube.

### BACKGROUND

In the related art, there are wires and pipes connected between an air-conditioner indoor unit and an air-conditioner outdoor unit that are split-type. The wires and pipes include, but are not limited to, copper pipes, electric wires, and drainage pipes. Generally, these wires and pipes are covered with thermal insulation layers and adhesive tapes to protect these wires and pipes. However, this method is relatively weak in protection performance. In some other related art, air-conditioner decoration tubes are used to protect these wires and pipes while beautifying the appearance of buildings. However, these air-conditioner decoration tubes still have many problems. For example, the air-conditioner decoration tubes include straight tubes, and the straight tubes are relatively large in volume, which leads to a large occupied space and is inconvenient for packaging and transportation. Appearance surfaces of the straight tubes are also easily damaged during the packaging and transportation.

### SUMMARY

The present disclosure aims to at least solve one of the technical problems in the related art to some extent. To this end, the present disclosure provides an air-conditioner decoration tube.

To achieve the above-mentioned purpose, the present disclosure discloses an air-conditioner decoration tube. The air-conditioner decoration tube includes a straight tube. The straight tube includes a first tube housing and a second tube housing. The straight tube has a first state and a second state. In the first state, the first tube housing is embedded in the second tube housing, and an outer surface of the first tube housing is covered by the second tube housing. In the second state, the first tube housing is connected to the second tube housing in such a manner that a tube cavity is enclosed by the first tube housing and the second tube housing.

In some embodiments of the present disclosure, the first tube housing has a first recessed cavity, and the second tube housing has a second recessed cavity. In the first state, the first tube housing is embedded in the second recessed cavity, and the outer surface of the first tube housing faces towards a cavity wall of the second recessed cavity. In the second state, the first recessed cavity is in communication with the second recessed cavity to form the tube cavity.

In some embodiments of the present disclosure, the second tube housing is provided with limiting ribs at two opposite sides of the second recessed cavity. The limiting ribs are adapted to limit the first tube housing when the first tube housing is embedded in the second recessed cavity.

In some embodiments of the present disclosure, the second tube housing is provided with a protruding rib at the cavity wall of the second recessed cavity. The first tube housing abuts against the protruding rib when the first tube housing is embedded in the second recessed cavity.

In some embodiments of the present disclosure, the protruding rib includes a first protruding rib and a second protruding rib that are spaced apart from each other. An engagement groove is formed between the first protruding rib and the second protruding rib. The air-conditioner decoration tube further includes a snap. The snap is adapted to be fixed in the engagement groove and has a perforated groove.

In some embodiments of the present disclosure, the snap is adapted to be fixed in the engagement groove through rotating subsequent to the snap being placed in the engagement groove.

In some embodiments of the present disclosure, the perforated groove is provided with vertical plates at two opposite sides of the perforated groove.

In some embodiments of the present disclosure, a surface of the snap is provided with arc-shaped portions at two sides of the snap in a diagonal direction of the snap.

In some embodiments of the present disclosure, the engagement groove extends in an extending direction of the straight tube.

In some embodiments of the present disclosure, the engagement groove is a groove opening a convex-like shape, and includes a sliding portion and an engagement portion. The snap is provided with a strip-shaped flange disposed on a side surface of the snap and a bow-shaped protruding portion disposed at an upper end of the snap. The snap is adapted to be placed in the engagement portion from the sliding portion, and is adapted to rotate subsequent to being placed in the engagement portion, in such a manner that the strip-shaped flange engages with the engagement portion.

In some embodiments of the present disclosure, the air-conditioner decoration tube further includes a corrugated tube. The corrugated tube includes a straight tube segment and a corrugated segment, and the corrugated segment has an inner ring and an outer ring. The inner ring fits with the straight tube segment, in such a manner that the inner ring is sleeved over the straight tube segment.

In some embodiments of the present disclosure, the air-conditioner decoration tube further includes a connector. The connector includes a first half portion and a second half portion. The first half portion and the second half portion are engaged with each other in such a manner that a wire accommodation cavity is enclosed by the first half portion and the second half portion; the first half portion has a first connection hole exposed eternally; the second half portion has a second connection hole exposed eternally. The first connection hole and the second connection hole correspond to each other when the first half portion and the second half portion are engaged with each other, in such a manner that the first half portion is connected to the second half portion by inserting a screw through the first connection hole, or the second half portion is connected to the first half portion by inserting a screw through the second connection hole.

In the technical solutions of the present disclosure, the straight tube includes the first tube housing and the second tube housing. When the air-conditioner decoration tube is in a packaging and transportation stage, the straight tube may be switched to the first state. In the first state, the first tube housing is embedded inside the second tube housing. In this way, space occupation is reduced, and a packaging volume is reduced. Moreover, since the outer surface of the first tube housing is covered by the second tube housing, the outer surface of the first tube housing can be prevented from being scratched. The outer surface of the first tube housing, which serves as an appearance surface of the product, is thus protected from being damaged. After the air-conditioner decoration tube is installed in a use environment, the first tube housing and the second tube housing are engaged with each other in such a manner that the tube cavity is enclosed by the first tube housing and the second tube housing, and wires and pipes connected between an air-conditioner indoor unit and an air-conditioner outdoor unit are protected because they are located in the tube cavity.

Other advantages of the present disclosure will be provided in part in the following description, or will become apparent in part from the following description, or can be learned from practicing of the present disclosure.

### BRIEF DESCRIPTION OF THE DRAWINGS

In order to clearly explain technical solutions of the embodiments of the present disclosure or in the related art, accompanying drawings used in the description of the embodiments or the related art are briefly described below. Obviously, the accompanying drawings as described below are merely some embodiments of the present disclosure. Based on structures illustrated in these drawings, other designs may be obtained by those of ordinary skill in the art without creative effort.

FIG. 1 is a schematic view of an air-conditioner decoration tube in some embodiments;

FIG. 2 is a schematic view of a straight tube in some embodiments (the straight tube is in a second state);

FIG. 3 is an exploded view of a straight tube in some embodiments;

FIG. 4 is an axial schematic view of a straight tube in some embodiments (the straight tube is in a second state);

FIG. 5 is a schematic view of a straight tube being switched to a first state in some embodiments;

FIG. 6 is a schematic view of an engagement groove in some embodiments;

FIG. 7 is a schematic view of a snap in some embodiments;

FIG. 8 is a schematic view of a snap being snapped into an engagement groove in some embodiments;

FIG. 9 is a schematic view of cooperation between a straight tube and a maintenance mechanism in some embodiments;

FIG. 10 is a schematic view of a maintenance mechanism in some embodiments;

FIG. 11 is a schematic view of a corrugated tube in some embodiments;

FIG. 12 is a schematic view of cooperation between a straight tube segment and a corrugated segment in a corrugated tube in some embodiments;

FIG. 13 is a partially enlarged view of a corrugated segment in some embodiments;

FIG. 14 is a schematic view of a connector in some embodiments;

FIG. 15 is a schematic view of a connector from another viewing angle in some embodiments; and

FIG. 16 is an exploded view of a connector in some embodiments.

### DESCRIPTION OF REFERENCE NUMERALS

air-conditioner decoration tube 100, straight tube 1000, first tube housing 1100, first recessed cavity 1110, outer surface 1120, second tube housing 1200, second recessed cavity 1210, limiting rib 1220, protruding rib 1230, first protruding rib 1231, second protruding rib 1232, engagement groove 1233, sliding portion 1234, engagement portion 1235, connection groove 1240, insertion groove 1250, tube cavity 1300, snap 2000, perforated groove 2100, bow-shaped protruding portion 2200, vertical plate 2300, arc-shaped portion 2400, strip-shaped flange 2500, maintenance mechanism 3000, connection plate 3100, closing plate 3200, engagement block 3300, storage housing 3400, ventilation groove 3500, box cover 3600, sliding block 3700, friction pad 3800, handling groove 3900, corrugated tube 4000, corrugated segment 4100, outer ring 4110, inner ring 4120, straight tube segment 4200, connector 5000, first half portion 5100, first connection hole 5110, second half portion 5200, second connection hole 5210, wire accommodation cavity 5300.

The implementation, functional characteristics, and advantages of the present disclosure will be further described in combination with the embodiments and with reference to the accompanying drawings.

### DETAILED DESCRIPTION

Technical solutions according to embodiments of the present disclosure will be described clearly and completely below in combination with accompanying drawings of the embodiments of the present disclosure. Obviously, the embodiments described below are only a part of the embodiments of the present disclosure, rather than all embodiments of the present disclosure. On a basis of the embodiments of the present disclosure, all other embodiments obtained by those skilled in the art without creative labor shall fall within the protection scope of the present disclosure.

It should be noted that all directional indications (such as up, down, left, right, front, and back, etc.) in the embodiments of the present disclosure are only configured to explain a relative position relationship, a motion situation, etc. between components (as shown in the drawings) in a certain specific posture. When the specific posture changes, the directional indication also changes accordingly.

In the present disclosure, unless otherwise clearly specified and limited, terms such as “connect to”, “fix”, and the like should be understood in a broad sense. For example, “fix” may be a fixed connection or a detachable connection or connection as one piece; mechanical connection or electrical connection; direct connection or indirect connection through an intermediate; internal communication of two components or the interaction relationship between two components. For those skilled in the art, the specific meaning of the above-mentioned terms in the present disclosure can be understood according to specific circumstances.

In addition, terms such as “first” and “second” involved in the present disclosure are used only for purposes of description and are not intended to indicate or imply relative importance or significance, or implicitly indicate the number of indicated technical features. Therefore, the features associated with “first” and “second” may explicitly or implicitly include at least one of the features. In addition, the technical solutions between the various embodiments may be combined with each other, but must be based on those of ordinary skill in the art. When the combination of the technical solutions is contradictory or cannot be implemented, it should be regarded that the combination of the technical solutions does not exist, nor is within the scope of the present disclosure.

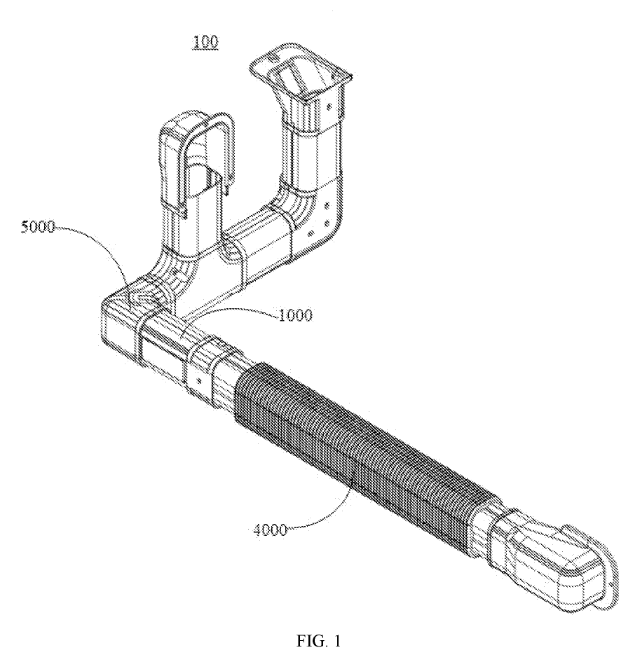

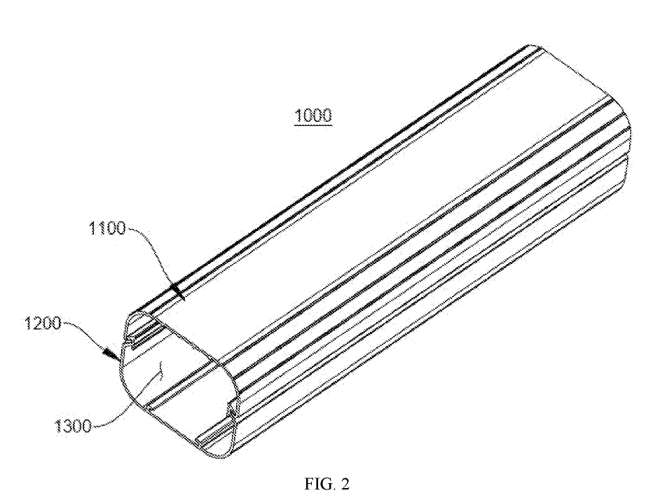

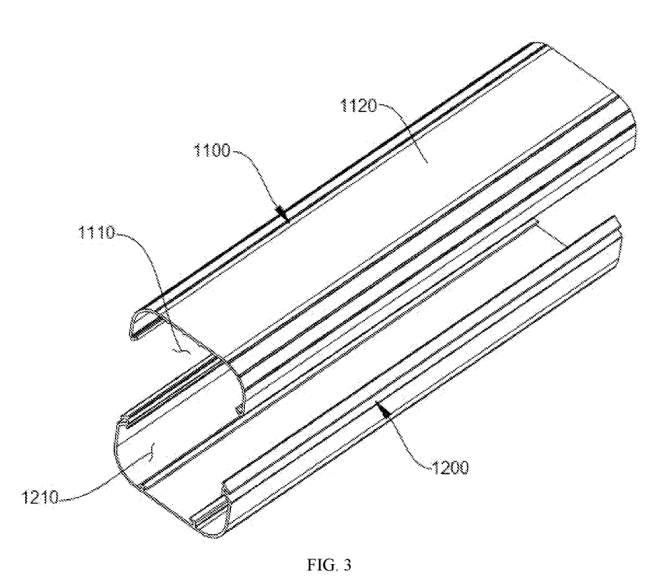

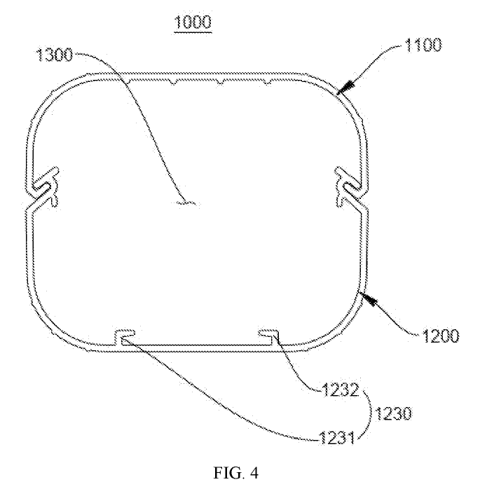

The present disclosure discloses an air-conditioner decoration tube 100. As shown in FIG. 1 to FIG. 5, in some embodiments, the air-conditioner decoration tube 100 includes a straight tube 1000. The straight tube 1000 includes a first tube housing 1100 and a second tube housing 1200, and has a first state and a second state. In the first state, the first tube housing 1100 is embedded in the second tube housing 1200, and an outer surface 1120 of the first tube housing 1100 is covered by the second tube housing 1200. In the second state, the first tube housing 1100 is connected to the second tube housing 1200 in such a manner that a tube cavity 1300 is enclosed by the first tube housing 1100 and the second tube housing 1200.

In this embodiment, the straight tube 1000 includes the first tube housing 1100 and the second tube housing 1200. When the air-conditioner decoration tube 100 is in a packaging and transportation stage, the straight tube 1000 may be switched to the first state. In the first state, the first tube housing 1100 is embedded inside the second tube housing 1200. In this way, space occupation is reduced, and a packaging volume is reduced. Moreover, since the outer surface 1120 of the first tube housing 1100 is covered by the second tube housing 1200, the outer surface 1120 of the first tube housing 1100 can be prevented from being scratched and damaged. The outer surface 1120 of the first tube housing 1100, which serves as an appearance surface of the product, is thus protected from being damaged. After the air-conditioner decoration tube 100 is installed in a use environment, the first tube housing 1100 and the second tube housing 1200 are engaged with each other in such a manner that the tube cavity 1300 is enclosed by the first tube housing 1100 and the second tube housing 1200, and wires and pipes connected between an air-conditioner indoor unit and an air-conditioner outdoor unit are protected because they are located in the tube cavity 1300.

Specifically, the air-conditioner decoration tube 100 is applied to the protection of the wires and pipes connected between the air-conditioner indoor unit and the air-conditioner outdoor unit. The wires and pipes include, but are not limited to, copper pipes, electric wires, and drainage pipes that are configured to connect the air-conditioner indoor unit and the air-conditioner outdoor unit. The air-conditioner decoration tube 100 is of a hollow structure, and these wires and pipes are in a state of passing through the air-conditioner decoration tube 100 (i.e., the wires and pipes are placed inside the air-conditioner decoration tube 100). In order to adapt to different use environments, the air-conditioner decoration tube 100 includes a plurality of connected pipe fittings. A complete air-conditioner decoration tube 100 is assembled through the plurality of connected pipe fittings. Generally, the air-conditioner decoration tube 100 includes the straight tube 1000 (that is regarded as one of the plurality of pipe fittings), and the straight tube 1000 extends straight.

In the related art, a straight tube includes a first tube housing and a second tube housing. The first tube housing and the second tube housing are designed to be detachably connected, i.e., the first tube housing and the second tube housing are connectable and detachable from one another. The first tube housing is connected to the second tube housing, so that the straight tube is formed to protect the wires and pipes (the wires and pipes are in a state of passing through the straight tube). The first tube housing and the second tube housing are also detachable from one another, which facilitates performing maintenance on the wires and pipes. However, this straight tube still has many problems. For example, during packaging and transportation, although the straight tube may be disassembled into the first tube housing and the second tube housing, the straight tube still occupies a lot of space. Moreover, an appearance surface (a surface easily observed by a user) of the straight tube is easily scratched and damaged during the packaging and transportation, affecting the appearance. Therefore, this embodiment makes improvements.

In this embodiment, the straight tube 1000 still includes the first tube housing 1100 and the second tube housing 1200. However, compared with the related art, the straight tube 1000 has the first state and the second state. In the first state, the first tube housing 1100 is embedded in the second tube housing 1200. It can be understood that the so-called embedding means placing at least a part of one of the first tube housing 1100 and the second tube housing 1200 into the inside of the other one of the first tube housing 1100 and the second tube housing 1200. In this way, the first tube housing 1100 and the second tube housing 1200 may share at least part of the space. For example, the first tube housing 1100 is completely embedded inside the second tube housing 1200 and utilizes a space occupied by the second tube housing 1200. For another example, a part of the first tube housing 1100 is embedded inside the second tube housing 1200, and utilizes the space occupied by the second tube housing 1200. With this arrangement, when the straight tube 1000 is in the first state, a space occupied by the straight tube 1000 is smaller than spaces occupied respectively by the first tube housing 1100 and the second tube housing 1200. In this way, it is beneficial to reducing the space occupied by the straight tube 1000 during the packaging and transportation stage and reducing the packaging volume. A quantity of products transported at one time is increased, and costs are reduced. That is, the first state may be understood as a state in which the straight tube 1000 is applied to packaging and transportation. In addition, when the first tube housing 1100 is embedded in the second tube housing 1200, the outer surface 1120 of the first tube housing 1100 is covered by the second tube housing 1200. The second tube housing 1200 realizes protection for the outer surface 1120 of the first tube housing 1100. The outer surface 1120 of the first tube housing 1100, as the appearance surface, is not easily damaged during the packaging and transportation. After the straight tube 1000 is installed in the use environment, the outer surface 1120 of the first tube housing 1100 remains intact in appearance.

In the second state, the first tube housing 1100 is connected to the second tube housing 1200 in such a manner that a tube cavity 1300 is enclosed by the first tube housing 1100 and the second tube housing 1200. The wires and pipes are arranged in the tube cavity 1300 and thus protected by the straight tube 1000. Generally, an installation process is described below. The second tube housing 1200 is fixedly connected to a wall. Then, the wires and pipes are arranged corresponding to the second tube housing 1200. For example, the wires and pipes are fixedly connected to the second tube housing 1200. Then, the first tube housing 1100 is connected to the second tube housing 1200. The first tube housing 1100 covers the wires and pipes. The tube cavity 1300 is enclosed by the first tube housing 1100 and the second tube housing 1200. The wires and pipes are then located in the tube cavity 1300. After the first tube housing 1100 and the second tube housing 1200 are connected, the outer surface 1120 of the first tube housing 1100 forms the appearance surface and is observed by the user. That is, the second state may be understood as a state in which the straight tube 1000 is installed in the use environment. Since the outer surface 1120 of the first tube housing 1100 is protected when the straight tube 1000 is in the first state, the outer surface 1120 of the first tube housing 1100 is not easily scratched after the first tube housing 1100 is connected to the second tube housing 1200.

Continuing with reference to FIGS. 1 to 5, in some embodiments, the first tube housing 1100 has a first recessed cavity 1110, and the second tube housing 1200 has a second recessed cavity 1210. Specifically, the first tube housing 1100 extends in an extending direction of the straight tube 1000, and the first recessed cavity 1110 also extends in the extending direction of the straight tube 1000. The first recessed cavity 1110 opens towards the second tube housing 1200. Similarly, the second tube housing 1200 extends in the extending direction of the straight tube 1000, and the second recessed cavity 1210 also extends in the extending direction of the straight tube 1000. The second recessed cavity 1210 opens towards the first tube housing 1100.

When the straight tube 1000 is in the first state, the first tube housing 1100 is embedded in the second recessed cavity 1210, and the outer surface 1120 of the first tube housing 1100 faces towards a cavity wall of the second recessed cavity 1210. In this way, the first tube housing 1100 makes the utmost of the space occupied by the second tube housing 1200 and may form the protection for the outer surface 1120 of the first tube housing 1100. For example, with the second recessed cavity 1210 opening upwards as a reference, the first recessed cavity 1110 also opens upwards. The first tube housing 1100 is placed into the second recessed cavity 1210 from top to bottom, so that the first tube housing 1100 makes the utmost of the space occupied by the second tube housing 1200.

When the straight tube 1000 is in the second state, the first tube housing 1100 and the second tube housing 1200 are connected, so that the first recessed cavity 1110 is in communication with the second recessed cavity 1210 to form the tube cavity 1300. Generally, in order to facilitate the connection between the first tube housing 1100 and the second tube housing 1200 and the enclosure of the tube cavity 1300 by the first tube housing 1100 and the second tube housing 1200, the first tube housing 1100 and the second tube housing 1200 are fixedly connected by means of a snap-connection. For example, the second tube housing 1200 is fixedly connected to the wall. Then, the wires and pipes are placed or fixed in the second recessed cavity 1210. Then, two opposite sides of the first tube housing 1100 and two opposite sides of the second tube housing 1200 respectively correspond to each other, and are fixedly connected by means of the snap-connection.

As shown in FIG. 5, in some embodiments, the second tube housing 1200 is provided with limiting ribs 1220 at two opposite sides of the second recessed cavity 1210. The limiting ribs 1220 are adapted to limit the first tube housing 1100 when the first tube housing 1100 is embedded in the second recessed cavity 1210. In this way, the first tube housing 1100 and the second tube housing 1200 are relatively fixed when the straight tube 1000 is in the first state, preventing the first tube housing 1100 from being disengaged from the second recessed cavity 1210 during the packaging and transportation.

Specifically, taking the second recessed cavity 1210 opening upwards as a reference, the first recessed cavity 1110 of the first tube housing 1100 also opens upwards. The first tube housing 1100 is controlled to move from up to down and be embedded in the second recessed cavity 1210. After the first tube housing 1100 is embedded in the second recessed cavity 1210, the limiting ribs 1220 limit a top of the first tube housing 1100, thus blocking the first tube housing 1100 from up to down (in a direction away from the second recessed cavity 1210). The first tube housing 1100 is not easy to be disengaged from the second recessed cavity 1210.

For example, the first tube housing 1100 and the second tube housing 1200 are respectively formed through injection molding and both have a predetermined elasticity. During a process of the first tube housing 1100 being embedded in the second recessed cavity 1210, the second tube housing 1200 deforms to allow the first tube housing 1100 to be smoothly embedded in the second recessed cavity 1210. When the first tube housing 1100 is embedded in a predetermined position, the second tube housing 1200 recovers its deformation, so that the limiting ribs 1220 block the first tube housing 1100.

As shown in FIG. 5, in some embodiments, the second tube housing 1200 is provided with a protruding rib 1230 at the cavity wall of the second recessed cavity 1210. The first tube housing 1100 abuts against the protruding rib 1230 when the first tube housing 1100 is embedded in the second recessed cavity 1210. By providing the protruding rib 1230, a contact area between the outer surface 1120 of the first tube housing 1100 and the cavity wall of the second recessed cavity 1210 is further reduced. In this way, the protection for the outer surface 1120 of the first tube housing 1100 is further formed, and it is more conducive to preventing the outer surface 1120 of the first tube housing 1100 from being worn. Optionally, the protruding rib 1230 extends in the extending direction of the straight tube 1000, so that the protruding rib 1230 may abut against the outer surface 1120 of the first tube housing 1100 in the extending direction of the straight tube 1000.

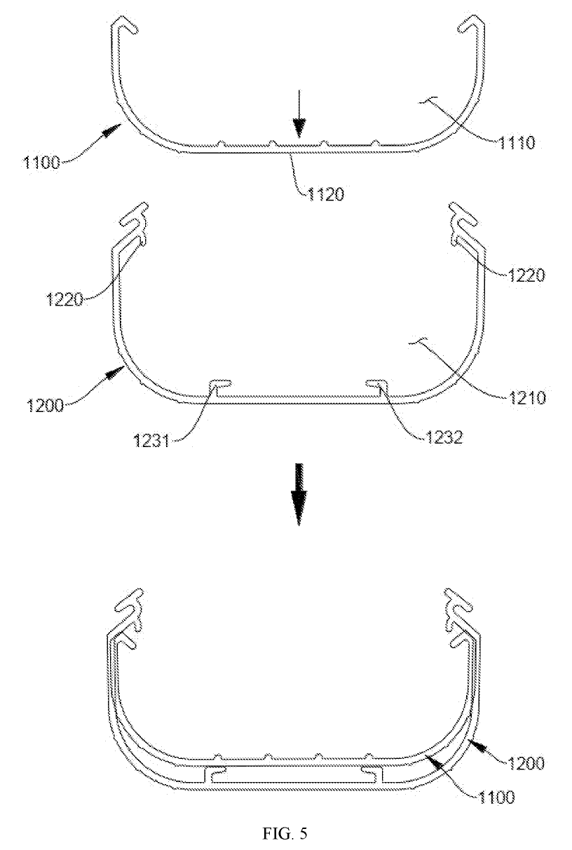

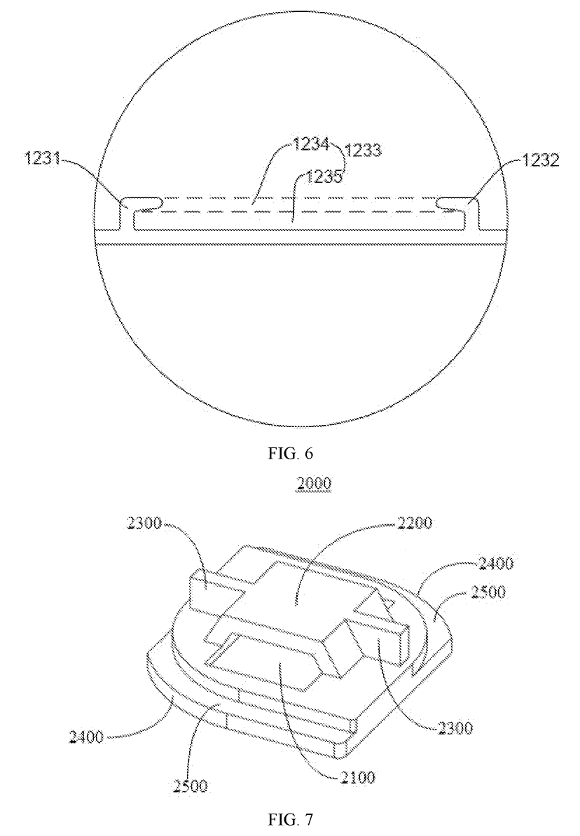

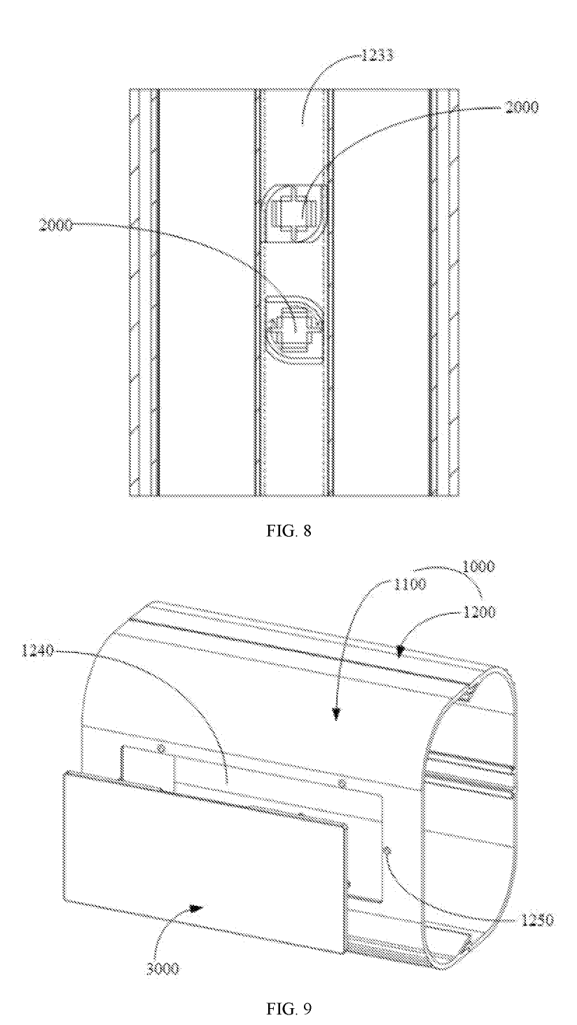

As shown in FIGS. 5 to 8, in some embodiments, the protruding rib 1230 includes a first protruding rib 1231 and a second protruding rib 1232 that are spaced apart from each other. An engagement groove 1233 is formed between the first protruding rib 1231 and the second protruding rib 1232. The air-conditioner decoration tube 100 further includes a snap 2000. The snap 2000 is adapted to be fixed in the engagement groove 1233.

As can be seen from the above, the wires and pipes need to be placed in the tube cavity 1300 to be in the state of passing through the straight tube 1000. In order to realize the fixation of the wires and pipes, the air-conditioner decoration tube 100 further includes the snap 2000. The snap 2000 is fixed in the tube cavity 1300, and a cable tie may be used to tie the wires and pipes to the snap 2000, thereby realizing the fixation of the wires and pipes. For example, the snap 2000 has a perforated groove 2100. The cable tie passes through the perforated groove 2100 and ties the wires and pipes, so that the fixation of the wires and pipes is realized.

Fixation of the snap 2000 is realized based on the arrangement of the protruding rib 1230. The protruding rib 1230 includes the first protruding rib 1231 and the second protruding rib 1232. The first protruding rib 1231 extends in the extending direction of the straight tube 1000, and the second protruding rib 1232 also extends in the extending direction of the straight tube 1000. The first protruding rib 1231 and the second protruding rib 1232 are spaced apart from each other, so that the engagement groove 1233 is formed between the first protruding rib 1231 and the second protruding rib 1232. The snap 2000 is fixed in the engagement groove 1233. Since each of the first protruding rib 1231 and the second protruding rib 1232 extends in the extending direction of the straight tube 1000, the engagement groove 1233 also extends in the extending direction of the straight tube 1000. The snap 2000 may be fixed at any position in the engagement groove 1233, which can better form the fixation of the wires and pipes.

Optionally, in order to facilitate the fixation of the snap 2000 in the engagement groove 1233, in some embodiments, the snap 2000 is adapted to be fixed in the engagement groove 1233 through rotating subsequent to the snap 2000 being placed in the engagement groove 1233, i.e., when the snap 2000 is installed, the snap 2000 is aligned with the engagement groove 1233. At this time, the snap 2000 in a width direction of an opening of the engagement groove 1233 is smaller than or equal to an opening size of the engagement groove 1233. In this way, it is facilitated that the snap 2000 may be placed in the engagement groove 1233. After the snap 2000 is placed in the engagement groove 1233, the snap 2000 is rotated. A rotation angle may be determined based on an actual situation. For example, after the snap 2000 rotates 90 degrees, the snap 2000 in the width direction of the opening of the engagement groove 1233 is greater than the opening size of the engagement groove 1233, so that the snap 2000 may not be disengaged from the engagement groove 1233, to complete the fixation of the snap 2000. As can be seen from the above, since the engagement groove 1233 extends in the extending direction of the straight tube 1000, it is convenient to fix the snap 2000 at any position in the engagement groove 1233 through this arrangement.

For example, in some embodiments, the engagement groove 1233 is a groove opening in a convex-like shape. The engagement groove 1233 includes a sliding portion 1234 and an engagement portion 1235, i.e., the sliding portion 1234 forms the opening of the engagement groove 1233, and the engagement portion 1235 forms a bottom of the engagement groove 1233. Since the engagement groove 1233 is a groove opening (structure) in a convex-like shape, a width of the sliding portion 1234 is smaller than a width of the engagement portion 1235. The snap 2000 is provided with a strip-shaped flange 2500 disposed on a side surface of the snap 2000 and a bow-shaped protruding portion 2200 disposed at an upper end of the snap 2000. The snap 2000 is adapted to be placed in the engagement portion 1235 from the sliding portion 1234, and is adapted to rotate subsequent to being placed in the engagement portion 1235, in such a manner that the strip-shaped flange 2500 engages with the engagement portion 1235.

Specifically, since the engagement groove 1233 extends in the extending direction of the straight tube 1000, the bow-shaped protruding portion 2200 of the snap 2000 is convenient to form the perforated groove 2100.

A process of installing the snap 2000 into the engagement groove 1233 is described below. The snap 2000 is placed into the engagement groove 1233 at a required installation position. The snap 2000 passes through the sliding portion 1234 and is placed into the engagement portion 1235, making the snap 2000 keep fit with the bottom of the engagement groove 1233 (a bottom of the engagement portion 1235), while rotating the snap 2000 by a predetermined angle (such as 90°). In this way, the strip-shaped flange 2500 of the snap 2000 is engaged into the engagement groove 1233, which makes the snap 2000 in an interference fit with the engagement groove 1233 and realizes fixation of the snap 2000 and the straight tube 1000 (the second tube housing 1200). Then, the cable tie passes through the perforated groove 2100, and the wires and pipes are tied, to realize the fixation of the wires and pipes and the straight tube 1000 (the second tube housing 1200).

Further, as shown in FIG. 5, the perforated groove 2100 is provided with vertical plates 2300 at two opposite sides of the perforated groove 2100. Since the snap 2000 needs to rotate, by respectively providing the vertical plates 2300 at the two opposite sides of the perforated groove 2100, an operator squeezes the vertical plates 2300 with index finger and thumb, which is convenient to exert force to rotate the snap 2000, thereby making the snap 2000 be fixed or removed.

Further, as shown in FIG. 5, a surface of the snap 2000 is provided with arc-shaped portions 2400 at two sides of the snap 2000 in a diagonal direction of the snap 2000. The arrangement of the arc-shaped portions 2400 enables the snap 2000 to have enough space to rotate in the engagement groove 1233 when the snap 2000 rotates, to satisfy movement requirements of the snap 2000.

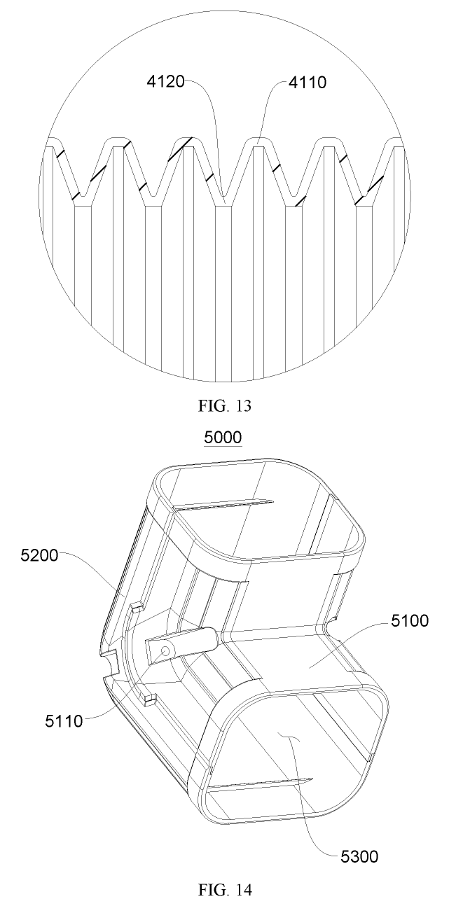

As shown in FIGS. 1, 11, 12, and 13, and , in some embodiments, the air-conditioner decoration tube 100 further includes a corrugated tube 4000. The corrugated tube 4000 includes a straight tube segment 4200 and a corrugated segment 4100, and the corrugated segment 4100 has an inner ring 4120 and an outer ring 4110. The inner ring 4120 fits with the straight tube segment 4200, in such a manner that the inner ring 4120 is sleeved over the straight tube segment 4200.

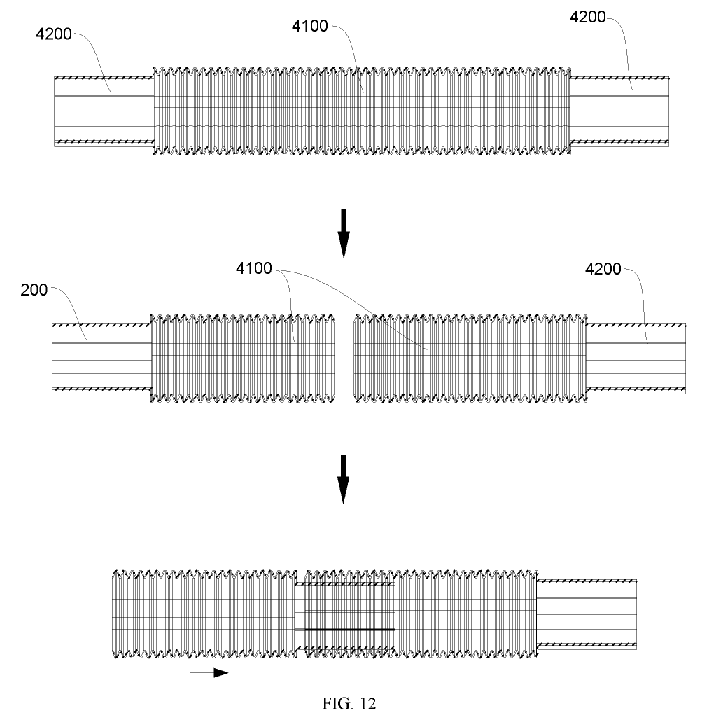

As shown in FIG. 12, the corrugated tube 4000 includes two straight tube segments 4200 and one corrugated segment 4100. The corrugated segment 4100 is provided with straight tube segments 4200 at two ends of the corrugated segment 4100, respectively. The corrugated segment 4100 has a plurality of inner rings 4120 and a plurality of outer rings 4110. “Plurality of” means two or more. The inner rings 4120 and the outer rings 4110 are alternately arranged in an extending direction of the corrugated tube 4000. In some cases, the corrugated segment 4100 needs to be cut into two parts. In this way, one part of the corrugated segment 4100 has a straight pipe segment 4200, and the other part of the corrugated segment 4100 also has a straight pipe segment 4200. The straight pipe segment 4200 on the one part of the corrugated segment 4100 may be inserted into the other part of the corrugated segment 4100. In this way, more use scenarios can be satisfied.

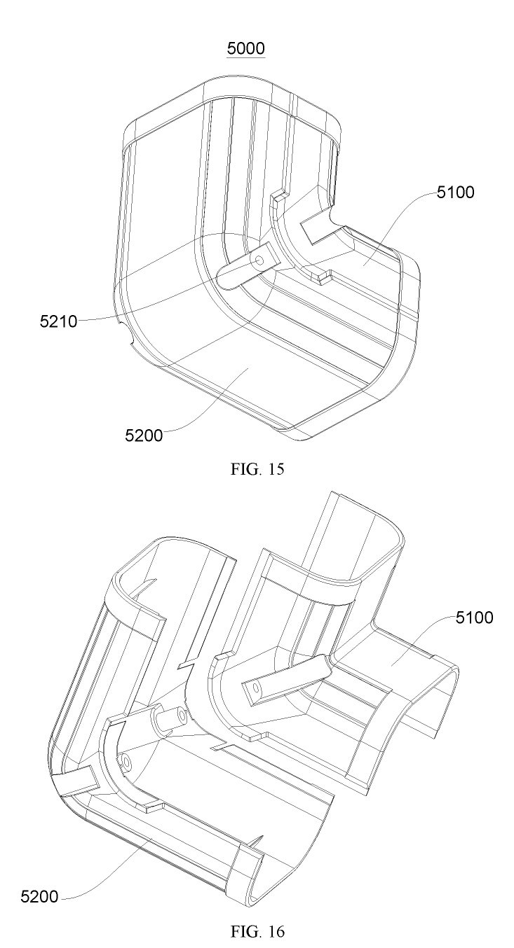

As shown in FIGS. 1 and 14 to 16, in some embodiments, the air-conditioner decoration tube 100 further includes a connector 5000. The connector 5000 includes a first half portion 5100 and a second half portion 5200. The first half portion 5100 and the second half portion 5200 are engaged with each other in such a manner that a wire accommodation cavity 5300 is enclosed by the first half portion 5100 and the second half portion 5200. The first half portion 5100 has a first connection hole 5110 exposed eternally. The second half portion 5200 has a second connection hole 5210 exposed eternally. The first connection hole 5110 and the second connection hole 5210 correspond to each other when the first half portion 5100 and the second half portion 5200 are engaged with each other, in such a manner that the first half portion 5100 is connected to the second half portion 5200 by inserting a screw through the first connection hole 5110, or the second half portion 5200 is connected to the first half portion 5100 by inserting a screw through the second connection hole 5210.

Specifically, the connector 5000 includes, but is not limited to, a right-angle connector and a tee connector. The connector 5000 includes the first half portion 5100 and the second half portion 5200. The first half portion 5100 and the second half portion 5200 are engaged with each other to form the wire accommodation cavity 5300. The wires and pipes are placed in the wire accommodation cavity 5300 and is protected. The first half portion 5100 has a first connection hole 5110 exposed eternally, and the second half portion 5200 has a second connection hole 5210 exposed eternally. The so-called “exposed eternally” means that it is exposed to the outside and may be observed. Since the first connection hole 5110 and the second connection hole 5210 are formed correspondingly, it is possible to insert the screw through the first connection hole 5110 or through the second connection hole 5210. When the screw is inserted through the first connection hole 5110, the first connection hole 5110 may be connected to the second connection hole 5210 through the screw to realize the connection and fixation of the first half portion 5100 and the second half portion 5200. When the screw is inserted through the second connection hole 5210, the second connection hole 5210 may also be connected to the first connection hole 5110 through the screw to realize the connection and fixation of the second half portion 5200 and the first half portion 5100, i.e., the connection of the first half portion 5100 and the second half portion 5200 may be achieved by inserting screws in two directions, which is more convenient for assembly of the first half portion 5100 and the second half portion 5200 and can satisfy more use scenarios.

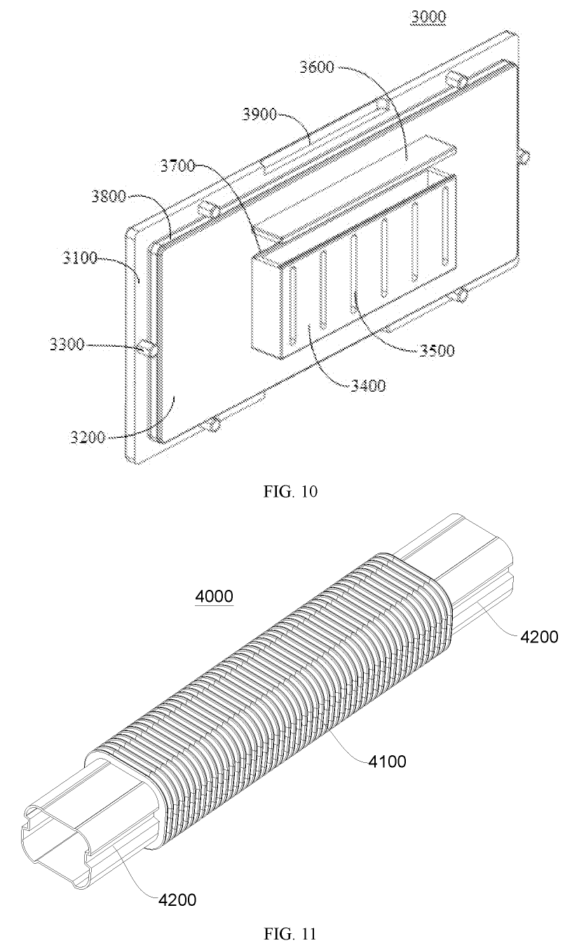

As shown in FIGS. 9 and 10, in some embodiments, a maintenance mechanism 3000 is provided on a surface of the straight tube 1000. For example, the maintenance mechanism 3000 is provided on a surface of the first tube housing 1100. The maintenance mechanism 3000 includes a connection plate 3100. A closing plate 3200 and engagement blocks 3300 are fixed on a surface of the connection plate 3100. A plurality of engagement blocks 3300 is provided. A connection groove 1240 is formed at a side surface of the straight tube 1000 (such as the surface of the first tube housing 1100) and cooperates with the closing plate 3200 for use. Moreover, an insertion groove is formed at a side surface of the straight tube 1000 (such as the surface of the first tube housing 1100) and cooperates with the engagement blocks 3300 for use. A storage housing 3400 is fixed on a surface of the closing plate 3200. A ventilation groove 3500 is formed on a surface of the storage housing 3400. A sliding block 3700 is fixed on a top of the storage housing 3400. A box cover 3600 is slidably connected to a surface of the sliding block 3700. The storage housing 3400 is internally provided with desiccant.

The connection plate 3100 is engaged to the surface of the straight tube 1000 through the closing plate 3200 and the engagement blocks 3300. The closing plate 3200 may enter the connection groove 1240 to close the surface of the straight tube 1000 (the first tube housing 1100). The engagement blocks 3300 may enter the insertion groove 1250, so that the connection plate 3100 is fixed on the surface of the straight tube 1000 through a friction force, enabling the connection plate 3100 to be quickly disassembled and assembled with the straight tube 1000 (the first tube housing 1100), thereby making installation and maintenance of the wires and pipes inside the straight tube 1000 more convenient. With this arrangement, the snap 2000 is also allowed to be easier to be installed into the engagement groove 1233 and be removed from the engagement groove 1233. The desiccant inside the storage housing 3400 may absorb moisture inside the straight tube 1000 (the tube cavity 1300), which prevents problems such as a decrease in performance or a corrosion failure of an electric wire insulation layer in the wires and pipes caused by too high humidity, thereby prolonging a service life of the wires and pipes and improving safety. Moreover, after the connection plate 3100 is separated from the straight tube 1000 (the first tube housing 1100), the box cover 3600 may slide away from the top of the storage housing 3400, making the desiccant inside the storage housing 3400 easier to be replaced.

Further, in some embodiments, a friction pad 3800 is fixed on the surface of the closing plate 3200. The friction pad 3800 is made of rubber. After the closing plate 3200 enters the connection groove 1240, the friction pad 3800 will be compressed and deformed, thereby increasing a friction force between the closing plate 3200 and the connection groove 1240, further preventing the connection plate 3100 from falling off naturally and also enhancing sealing performance.

Further, in some embodiments, the sliding block 3700 is provided in an L-shaped structure. A bottom shape of the box cover 3600 is adapted to the sliding block 3700. The sliding block 3700 is set in an L-shape, which can prevent the box cover 3600 from being vertically separated from the surface of the storage housing 3400.

Further, in some embodiments, handling grooves 3900 are formed at upper and lower surfaces of the connection plate 3100. The arrangement of the handling grooves 3900 enables the operator to normally take and place the connection plate 3100.

The embodiments as described above are merely preferred embodiments of the present disclosure, and is not therefore intended to limit the scope of the present disclosure. Any equivalent structural modification made based on the specification and the accompanying drawings of the present disclosure, or directly/indirectly application to other related art, are all included within the scope of the present disclosure under the inventive concept of the present disclosure.

What is claimed is:

1. An air-conditioner decoration tube, comprising a straight tube, wherein the straight tube comprises a first tube housing and a second tube housing, and wherein the straight tube has a first state and a second state, wherein:
in the first state, the first tube housing is embedded in the second tube housing, and an outer surface of the first tube housing is covered by the second tube housing; and
in the second state, the first tube housing is connected to the second tube housing in such a manner that a tube cavity is enclosed by the first tube housing and the second tube housing.

2. The air-conditioner decoration tube according to claim 1, wherein the first tube housing has a first recessed cavity, and wherein the second tube housing has a second recessed cavity, wherein:
in the first state, the first tube housing is embedded in the second recessed cavity, and the outer surface of the first tube housing faces towards a cavity wall of the second recessed cavity; and
in the second state, the first recessed cavity is in communication with the second recessed cavity to form the tube cavity.

3. The air-conditioner decoration tube according to claim 2, wherein the second tube housing is provided with limiting ribs at two opposite sides of the second recessed cavity, the limiting ribs being adapted to limit the first tube housing when the first tube housing is embedded in the second recessed cavity.

4. The air-conditioner decoration tube according to claim 2, wherein the second tube housing is provided with a protruding rib at the cavity wall of the second recessed cavity, the first tube housing abutting against the protruding rib when the first tube housing is embedded in the second recessed cavity.

5. The air-conditioner decoration tube according to claim 4, wherein the protruding rib comprises a first protruding rib and a second protruding rib that are spaced apart from each other, an engagement groove being formed between the first protruding rib and the second protruding rib,
wherein the air-conditioner decoration tube further comprises a snap, the snap being adapted to be fixed in the engagement groove and having a perforated groove.

6. The air-conditioner decoration tube according to claim 5, wherein the snap is adapted to be fixed in the engagement groove through rotating subsequent to the snap being placed in the engagement groove.

7. The air-conditioner decoration tube according to claim 6, wherein:
the perforated groove is provided with vertical plates at two opposite sides of the perforated groove; and/or
a surface of the snap is provided with arc-shaped portions at two sides of the snap in a diagonal direction of the snap; and/or
the engagement groove extends in an extending direction of the straight tube.

8. The air-conditioner decoration tube according to claim 6, wherein:
the engagement groove is a groove opening in a convex-like shape;
the engagement groove comprises a sliding portion and an engagement portion;
the snap is provided with a strip-shaped flange disposed on a side surface of the snap and a bow-shaped protruding portion disposed at an upper end of the snap,
wherein the snap is adapted to be placed in the engagement portion from the sliding portion, and is adapted to rotate subsequent to being placed in the engagement portion, in such a manner that the strip-shaped flange engages with the engagement portion.

9. The air-conditioner decoration tube according to claim 1, further comprising a corrugated tube, the corrugated tube comprising a straight tube segment and a corrugated segment, and the corrugated segment having an inner ring and an outer ring,
wherein the inner ring fits with the straight tube segment, in such a manner that the inner ring is sleeved over the straight tube segment.

10. The air-conditioner decoration tube according to claim 1, further comprising a connector, the connector comprising a first half portion and a second half portion, wherein:
the first half portion and the second half portion are engaged with each other in such a manner that a wire accommodation cavity is enclosed by the first half portion and the second half portion;
the first half portion has a first connection hole exposed eternally;
the second half portion has a second connection hole exposed eternally,
wherein the first connection hole and the second connection hole correspond to each other when the first half portion and the second half portion are engaged with each other, in such a manner that the first half portion is connected to the second half portion by inserting a screw through the first connection hole, or the second half portion is connected to the first half portion by inserting a screw through the second connection hole.
